(19) United States
(12) Patent Application Publication
(10) Pub. No.: US 2008/0303229 A1
(43) Pub. Date: Dec. 11, 2008

(54) SNOWMOBILE SLIDE

(76) Inventors: Donald BOWMAN, Lethbridge (CA); Randall BOWMAN, Lethbridge (CA)

Correspondence Address: DAVIS BUJOLD & Daniels, P.L.L.C., 112 PLEASANT STREET, CONCORD, NH, 03301, US

(21) Appl. No.: 12/117,790

(22) Filed: May 9, 2008

(30) Foreign Application Priority Data
Jun. 7, 2007 (CA) 2592493

(51) Int. Cl. B62B 17/02

(52) U.S. Cl. 280/28

(57) ABSTRACT

A snowmobile slide includes an elongated body having a first end, a second end, opposed sides, an upper sliding surface and a lower mounting surface. The upper sliding surface has more than one guide channel, with each guide channel extending between the first end and the second end. The lower mounting surface has a plurality of depending feet spaced at intervals between the opposed sides and between the first end and the second end. Spacing between the feet define an underlying flow area to allow for drainage and ventilation across the lower mounting surface.

### FIELD

The present invention relates to a snowmobile slide, which guides a sliding movement of a runner of a snowmobile.

### BACKGROUND

U.S. Pat. No. 5,546,870 (Meacham et al) and U.S. Pat. No. 7,040,436 (Schounard) illustrate and describe two snowmobile slides that have come in to common usage.

### SUMMARY

There is provided a snowmobile slide, which includes an elongated body having a first end, a second end, opposed sides, an upper sliding surface and a lower mounting surface. The upper sliding surface has more than one guide channel, with each guide channel extending between the first end and the second end. The lower mounting surface has a plurality of depending feet spaced at intervals between the opposed sides and between the first end and the second end. Spacing between the feet define an underlying flow area to allow for drainage and ventilation across the lower mounting surface.

### BRIEF DESCRIPTION OF THE DRAWINGS

The drawings are for the purpose of illustration only and are not intended to in any way limit the scope of the claims to the particular embodiment or embodiments shown, wherein:

FIG. 1 is a top perspective view of a preferred embodiment of snowmobile slide.

FIG. 2 is a bottom perspective view of the snowmobile slide illustrated in FIG. 1.

FIG. 3 is a top perspective view of the snowmobile slide illustrated in FIG. 1 shown interacting with a runner of a snowmobile.

FIG. 4 is a top perspective view of a first alternative embodiment of snowmobile slide.

FIG. 5 is a top perspective view of a second alternative embodiment of snowmobile slide.

FIG. 6 is a top perspective view of a third alternative embodiment of snowmobile slide.

### DETAILED DESCRIPTION OF THE PREFERRED EMBODIMENT

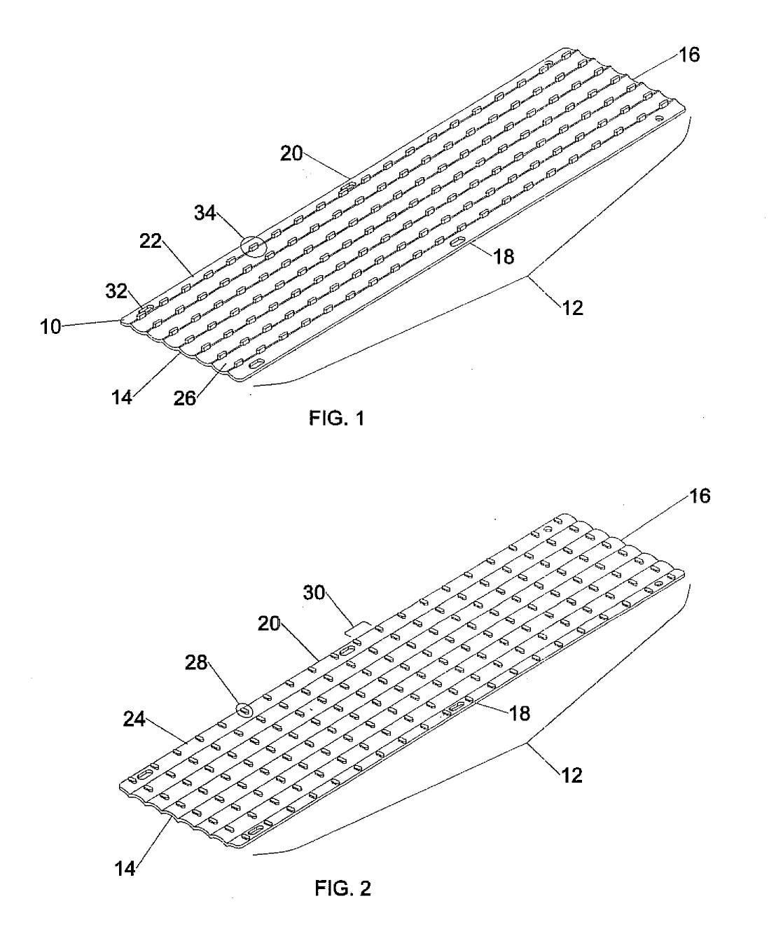

The preferred embodiment, a snowmobile slide generally identified by reference numeral 10, will now be described with reference to FIG. 1 through 3.

Structure and Relationship of Parts:

Referring to FIG. 1, snow mobile slide 10 includes an elongated body 12 having a first end 14, a second end 16, opposed sides 18 and 20 and an upper sliding surface 22. Referring to FIG. 2, a lower mounting surface 24 of body 12 is illustrated. Referring to FIG. 1, upper sliding surface 22 has more than one guide channel 26. Six centrally positioned guide channels 26 have been chosen for illustration. Each guide channel 26 extends for the length of body 12, between first end 14 and second end 16. Referring to FIG. 2, lower mounting surface 24 has a plurality of depending feet 28 spaced at intervals between opposed sides 18 and 20 and between first end 14 and second end 16. In the illustrated embodiment, feet 28 are in the form of truncated ribs arranged in a grid pattern. It will be appreciated that feet 28 need not be in the form of ribs and that a more random pattern of feet can be used. It is preferred that feet 28 provide support for the entire width and length of body 12. The spacing between feet 28 defines an underlying flow area, generally indicated by reference numeral 30. Referring to FIG. 1, mounting apertures 32 are positioned along opposed sides 18 and 20. Mounting apertures 32: extend through body 12 between upper sliding surface 22 and lower mounting surface 24, to allow for the use of fasteners to secure body 12. It is preferred that upper sliding surface have a non-slip traction surface positioned between guide channels 26 and extending between first end 14 and second end 16. In the preferred embodiment the non-slip traction surface is in the form of a plurality of upstanding members 34. Other forms of non-slip traction surfaces will hereinafter be shown as alternative embodiments. It is preferred that body 12, feet 28 on lower mounting surface 24 and upstanding members 34 on upper sliding surface 22 be integrally formed out of polymer plastic.

Operation:

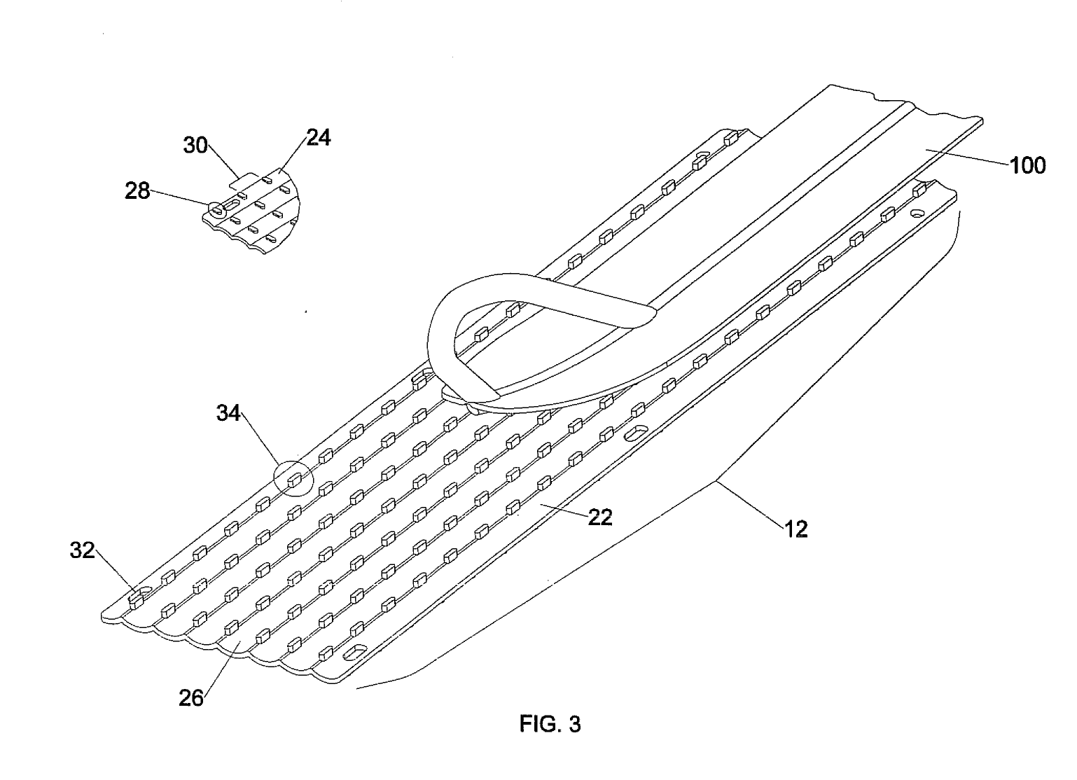

Referring to FIG. 3, body 12 is secured to a mounting surface, such as a deck, by fasteners which extend through mounting apertures 32. Feet 28 support lower mounting surface 24 above the deck. Flow area 30 between feet 28 allows water to drain from under lower mounting surface 24 and air flow ventilation across lower mounting surface 24. A runner 100 of a snowmobile (not shown) is able to slide along upper sliding surface 22, with such movement being guided by guide channels 26. However, when a person walks or a rubber tire from a vehicle drives across upper sliding surface 22, upstanding members 34 provide a non-slip traction surface to prevent slip and fall injuries or to provide traction for the rubber tire.

### Alternative embodiments

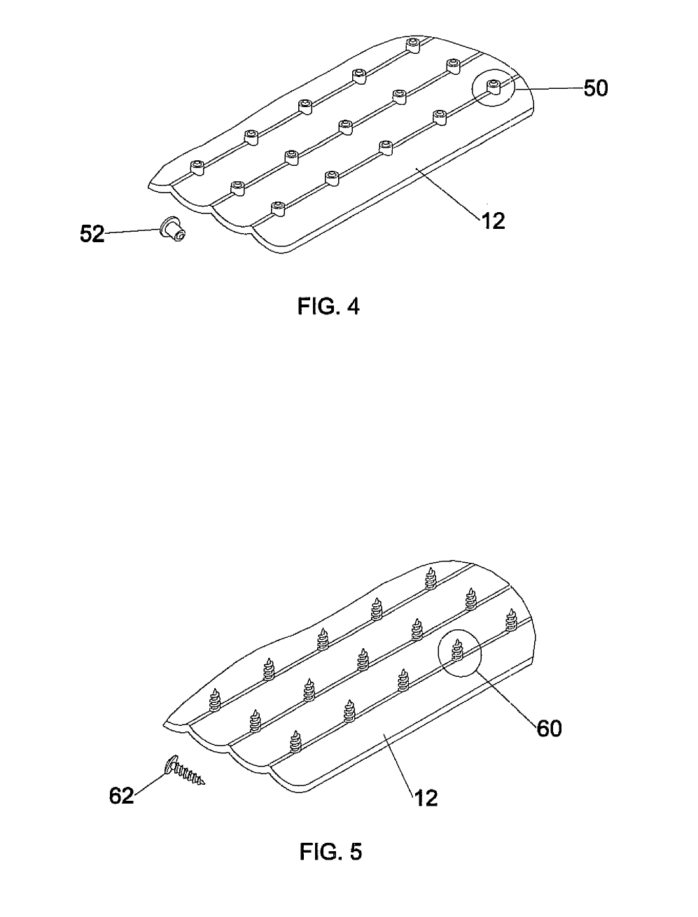

Referring to FIG. 4, a first alternative manner of providing a non-slip traction surface is to have body 12 formed out of polymer plastic with integral overmolded inserts 50. In this alternative embodiment the upstanding members are in the form of inserts 52 that are inserted into the plastic injection mold prior to injecting the polymer plastic.

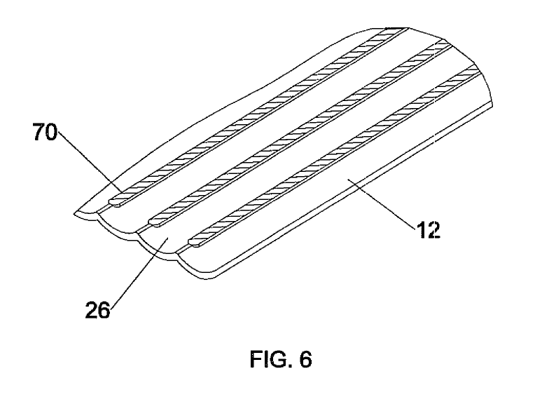

Referring to FIG. 5, a second alternative manner of providing a non-slip traction surface is to provide metal upstanding members 60 with body piercing tips 62. Metal upstanding members 60 can then be driven or screwed into body 12.

Referring to FIG. 6, a third alternative manner of providing a non-slip traction surface is to provide gnarled surfaces 70 on body 12 between guide channels 26.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from what is claimed.

What is claimed is:

1. A snowmobile slide, comprising:
an elongated body having a first end, a second end, opposed sides, an upper sliding surface and a lower mounting surface;
the upper sliding surface having more than one guide channel, each guide channel extending between the first end and the second end; and
the lower mounting surface having a plurality of depending feet spaced at intervals between the opposed sides and between the first end and the second end, spacing between the feet defining an underlying flow area to allow for drainage and ventilation across the lower mounting surface.

2. The snowmobile slide of claim 1, wherein mounting apertures are positioned along the opposed sides, the mounting apertures extending through the body between the upper sliding surface and the lower mounting surface.

3. The snowmobile slide of claim 1, wherein the upper sliding surface has a non-slip traction surface that is positioned between the guide channels and extends between the first end and the second end.

4. The snowmobile slide of claim 1, wherein the non-slip traction surface comprises a plurality of upstanding members positioned between the guide channels and spaced at intervals between the first end to the second end.

5. The snowmobile slide of claim 1, wherein the body, the feet on the lower mounting surface and the upstanding members on the upper sliding surface are integrally formed out of polymer plastic.

6. The snowmobile slide of claim 1, wherein the body is formed out of polymer plastic with integral overmolded inserts that are fit into the plastic injection mold prior to injecting the polymer plastic.

7. The snowmobile slide of claim 1, wherein the upstanding members are made of metal and have body piercing tips.

8. The snowmobile slide of claim 1, wherein the non-slip traction surface is a gnarled surface positioned between the guide channels.
